(19) United States
(12) Patent Application Publication
(10) Pub. No.: US 2026/0032316 A1
(43) Pub. Date: Jan. 29, 2026

(54) DISPLAY DEVICE AND OPERATING METHOD THEREOF

(71) Applicant: SAMSUNG ELECTRONICS CO., LTD., Suwon-si (KR)

(72) Inventors: Seongjin YUN, Suwon-si (KR); Boram KIM, Suwon-si (KR)

(73) Assignee: SAMSUNG ELECTRONICS CO., LTD., Suwon-si (KR)

(21) Appl. No.: 19/345,907

(22) Filed: Sep. 30, 2025

Related U.S. Application Data
(63) Continuation of application No. PCT/KR2024/004172, filed on Apr. 1, 2024.

(30) Foreign Application Priority Data
May 8, 2023 (KR) 10-2023-0059323

(51) Int. Cl. H04N 21/485; H04N 21/422; H04N 21/431

(52) U.S. Cl. CPC H04N 21/4858; H04N 21/42202; H04N 21/4316

(57) ABSTRACT

A display device may include a display configured to display an image content on a screen. The screen may include at least one corner area, and the at least one corner area may include a corner. The display device may further includes a sensor; a memory configured to store one or more instructions; and at least one processor. The one or more instructions, when executed the at least one processor individually or collectively, cause the display device to obtain information regarding illuminance around the display device through the sensor; control the display to display the image content on the screen with the corner having a curvature based on at least one of: illuminance information indicating illuminance around the display, or external device information; and control the display to display the image content on the screen.

### CROSS-REFERENCE TO RELATED APPLICATIONS

This application is a continuation of International Application No. PCT/KR2024/004172, filed on Apr. 1, 2024, which is based on and claims priority to Korean Patent Application No. 10-2023-0059323, filed on May 8, 2023, in the Korean Intellectual Property Office, the disclosures of which are incorporated by reference herein in their entireties.

### BACKGROUND

### 1. Field

The disclosure relates to a display device, in which curvature of a corner of a screen displayed on a display is adjustable, and an operating method thereof.

### 2. Description of Related Art

A display device is a device having a function of displaying an image viewable by a user. The user may view a broadcast via the display device. The display device displays, on a display, a broadcast selected by the user among broadcast signals transmitted from a broadcasting station. Also, a smart television (TV) providing various types of content, in addition to a broadcasting function, has been provided. A smart TV does not operate passively according to a user's selection, but performs a function of providing what the user wants by using existing viewing history information or the like of the user without the user's intervention.

To enhance visual immersion and aesthetics, curvature is applied to a corner of a display included in a mobile display device such as a smartphone, a tablet computer, or a smart watch. On the other hand, curvature is not applied to a corner of a display included in a display device such as a TV. Accordingly, when a TV and various mobile display devices interwork with each other, it is difficult for a user to continuously experience, on the TV, the same visual and aesthetic experiences as the mobile display devices.

### SUMMARY

According to an aspect of the disclosure, a display device may include a display configured to display an image content on a screen. The screen may include at least one corner area, and the at least one corner area may include a corner. The display device may further includes a sensor; a memory configured to store one or more instructions; and at least one processor. The one or more instructions, when executed the at least one processor individually or collectively, cause the display device to: obtain information regarding illuminance around the display device through the sensor; control the display to display the image content on the screen with the corner having a curvature based on at least one of: illuminance information regarding the illuminance around the display, or external device information; and control the display to display the image content on the screen.

The one or more instructions, when executed the at least one processor individually or collectively, cause the display device to: control the display to display a black image in a partial area of the corner area of the screen, such that a remaining area of the corner area has the curvature.

The one or more instructions, when executed the at least one processor individually or collectively, cause the display device to: control the display to deactivate an operation of a partial area of the corner area of the screen, such that a remaining area of the corner area has the curvature.

A value of the curvature decreases based on an illuminance value indicated by the illuminance information increasing, and increases based on the illuminance value decreasing.

The one or more instructions, when executed the at least one processor individually or collectively, cause the display device to: receive the image content from the external device connected to the display device; and control the display to display the image content on the screen with the corner having the curvature based on the external device information. The external device information comprises type information of the external device.

The one or more instructions, when executed the at least one processor individually or collectively, cause the display device to: receive the image content from the external device connected to the display device; and control the display to display the image content on the screen with the corner having the curvature based on the external device information. The external device information includes genre information of the image content.

The one or more instructions, when executed the at least one processor individually or collectively, cause the display device to: set a maximum curvature value of the corner of the screen based on the genre information of the image content.

The one or more instructions, when executed the at least one processor individually or collectively, cause the display device to: based on identifying that an object is present at an edge of the screen or in the corner of the screen, control the display device to change a value of the curvature of the corner of the screen based on an area where the object is present on the screen.

The one or more instructions, when executed the at least one processor individually or collectively, cause the display device to set a maximum curvature value of the corner of the screen based on the area where the object is present.

The one or more instructions, when executed the at least one processor individually or collectively, cause the display device to control the display to display the image content in a first area of the screen, display a letterbox in a second area of the screen, and cause a corner of the first area to have the curvature.

According to an aspect of the disclosure, an operating method of a display device may include obtaining illuminance information indicative of illuminance around the display device; controlling a display of the display device to display image content on a screen with a corner having a curvature corresponding to the illuminance information; and displaying image content on the screen.

The method may further include controlling the display of the display device to display the image content on the screen with the corner having the curvature includes controlling the display to display a black image in a partial area of a corner area of the screen, such that a remaining area of the corner area has the curvature.

The method may further include controlling the display of the display device to display the image content on the screen with the corner having the curvature includes controlling the display to deactivate operation of a partial area of a corner area of the screen, such that a remaining area of the corner area has the curvature.

A value of the curvature decreases when an illuminance value indicated by the illuminance information increases, and increases when the illuminance value decreases.

The method may further include adjusting the curvature based on external device information; and controlling the display of the display to display the image content on the screen with the corner having the adjusted curvature.

The external device information may be genre information of the image content provided by an external device or type information of the external device.

According to an aspect of the disclosure, a non-transitory computer-readable storage medium storing instructions that, when executed by a processor may perform the aforementioned operating method of the display device.

According to an aspect of the disclosure, a display device may include a display configured to display on a screen. The screen may include at least one corner area, and the at least one corner area may include a corner. The display device may further include a sensor; a memory configured to store one or more instructions; and at least one processor. The at least one processor may be configured to execute the one or more instructions to: control the display to display the image content on the screen with the corner having a curvature based on an absence of a displayed object in the corner area; and control the display to display the image content on the corner having no curvature based on a presence of the displayed object in the corner area.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram showing a display device according to an embodiment;

FIG. 2 is a flowchart of operations in which a display device controls curvature of a corner of a screen according to illuminance information, according to an embodiment;

FIG. 3 is a diagram for describing an operation in which curvature of a corner of a screen of a display device changes according to illuminance, according to an embodiment;

FIG. 4 is a diagram for describing a method by which a display device applies curvature to a corner of a screen, according to an embodiment;

FIG. 5 is a flowchart of operations in which a display device controls curvature of a corner of a screen, according to an embodiment;

FIG. 6 is a diagram for describing an operation in which a display device controls curvature of a corner of a screen according to external device information, according to an embodiment;

FIG. 7 is a diagram for describing an operation in which a display device controls curvature of a corner of a screen according to genre information of content, according to an embodiment;

FIG. 8 is a diagram showing an example in which a display device adjusts curvature of a corner of a screen when content is switched, according to an embodiment;

FIG. 9 is a diagram for describing a method by which, when a logo is included in a corner area of a screen, a display device applies curvature to the corner area of the screen, according to an embodiment;

FIG. 10 is a diagram for describing a method by which, when a logo is included in a corner area of a screen, a display device applies curvature to the corner area of the screen, according to an embodiment;

FIG. 11 is a diagram for describing a method by which, when an object is present in an edge area of a screen, a display device applies curvature to a corner area of the screen, according to an embodiment;

FIG. 12 is a diagram for describing an operation in which a display device controls curvature of a corner of a screen, based on a user input, according to an embodiment;

FIG. 13 is a diagram illustrating a method by which, when a letterbox is displayed on a display screen, a display device applies curvature, according to an embodiment;

FIG. 14 is a block diagram of a configuration of a display device, according to an embodiment; and

FIG. 15 is a block diagram of a configuration of a display device, according to an embodiment.

### DETAILED DESCRIPTION

The terms used in the present specification will be briefly defined, and the present disclosure will be described in detail.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, terms such as “unit”, “-or/-er”, and “module” described in the specification denote a unit that processes at least one function or operation, which may be implemented in hardware or software, or implemented in a combination of hardware and software.

Hereinafter, embodiments will be described in detail with reference to the accompanying drawings such that one of ordinary skill in the art may easily implement the present disclosure. However, the present disclosure may be implemented in various different forms and is not limited to an embodiment described herein. Also, in the drawings, parts irrelevant to the description are omitted in order to clearly describe the present disclosure, and like reference numerals designate like elements throughout the specification.

In the present specification, the term “user” according to an embodiment denotes a person who controls a system, a function, or an operation, and may include a developer, a manager, or an installation engineer.

Also, in the present specification, an “image” or a “picture” according to an embodiment may denote a still image, a moving image including a plurality of continuous still images (or frames), or a video.

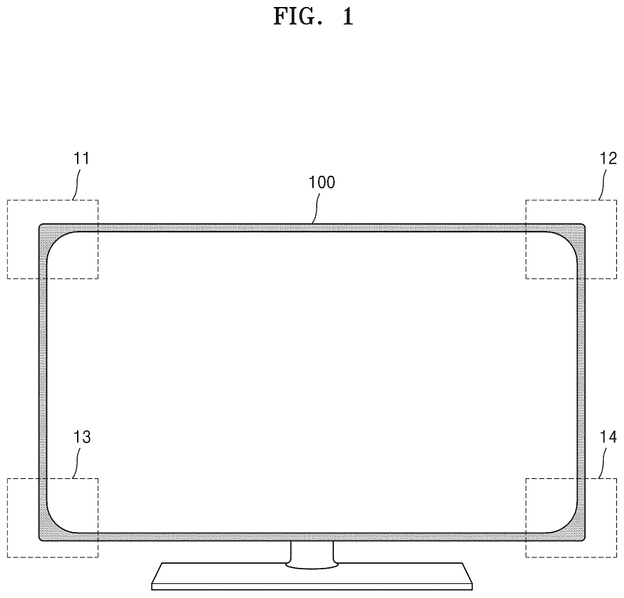

FIG. 1 is a diagram showing a display device according to an embodiment.

A display device 100 according to an embodiment may be a television (TV), but this is only an embodiment, and the display device 100 may be implemented in various forms including a display. For example, the display device 100 may be implemented as various electronic devices such as a mobile phone, a tablet personal computer (PC), a digital camera, a camcorder, a laptop computer, a desktop computer, an electronic book terminal, a digital broadcasting terminal, a personal digital assistant (PDA), a portable multimedia player (PMP), a navigation device, an MP3 player, and a wearable device. However, the present disclosure is not limited thereto.

Also, the display device 100 may be a fixed type or a movable type, and may be a digital broadcasting receiver capable of receiving a digital broadcast. Also, the display device 100 may be implemented as not only a display device with a flat screen, but also a curved display device with a screen having curvature or a flexible display device in which curvature of a screen is adjustable. Output definition of the display device 100 may include, for example, high definition (HD), full HD, ultra HD, or definition clearer than ultra HD. However, the present disclosure is not limited thereto.

The display device 100 according to an embodiment may control a display such that a corner of a screen appear to be round.

A method of rounding a corner of a screen of a display device may include generating a display panel to be round or controlling a rectangular display panel through software such that a corner of a screen appears to be round.

When the display panel is generated to be round, the extent of roundness of a corner of a screen is fixed, and thus, it is difficult to optimize the extent of roundness of the corner of the screen according to content displayed on the screen of a display. Thus, in the display device 100 according to an embodiment, the extent of roundness of the corner of the screen may be adjusted according to a usage environment, and thus, the screen optimized according to the usage environment may be provided.

For example, as shown in FIG. 1, curvature may be applied to the corner of the screen in the display device 100 such that the corner appears to be round rather than being sharp. The curvature indicates a value that represents the extent a curve or a curved surface is bent, and may be defined as the reciprocal of a radius of curvature. A radius of curvature is a radius of an imaginary circle that, when drawn at any point on a curved surface or curve, would have the same curvature as the curve passing through that point.

The screen according to an embodiment may include for corner areas (e.g., first, second, third, and fourth corner areas 11, 12, 13, and 14).

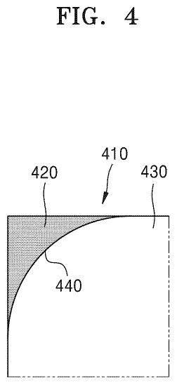

The display device 100 according to an embodiment may display a black image in a partial area of each corner area such that the corner of the screen appears to be round. Alternatively, an operation of the partial area of each corner area may be deactivated such that the corner appears to be round. This will be described in detail with reference to FIG. 4.

The display device 100 according to an embodiment may adjust the extent of roundness of the corner. The adjusting of the extent of roundness of the corner may indicate that a curvature value applied to the corner is adjusted. For example, when the curvature value increases, the corner of the screen appears to be more rounded, and when the curvature value decreases, the corner of the screen appears to be more squared.

The display device 100 according to an embodiment may adjust the extent of roundness of the corner of the screen (e.g., the curvature value of the corner of the screen), based on illuminance around the display device 100, information about an external device receiving content, genre information of the content, and whether an object is identified at an edge of the screen or in the corner area.

FIG. 1 illustrates an example in which a same curvature value is applied to the four corner areas (the first, second, third, and fourth corner areas 11, 12, 13, and 14), but the present disclosure is not limited thereto, and different curvature values may be applied to the four corner areas (the first, second, third, and fourth corner areas 11, 12, 13, and 14) or curvature may not be applied to some corner areas.

Hereinafter, operations in which the display device 100 according to an embodiment controls the curvature of the corner of the screen will be described in detail with reference to the drawings.

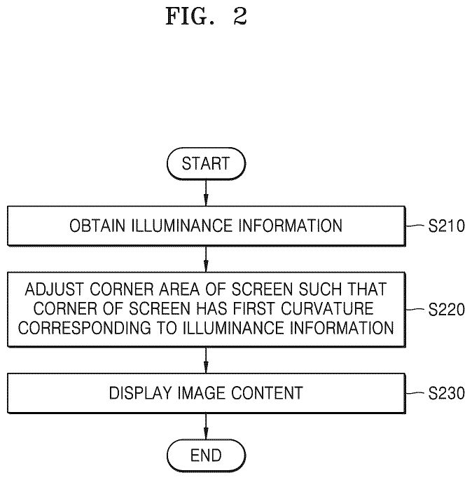

FIG. 2 is a flowchart of operations in which a display device controls curvature of a corner of a screen according to illuminance information, according to an embodiment.

Referring to FIG. 2, the display device 100 according to an embodiment may obtain information regarding illuminance of an environment around the display device 100 (S210).

The illuminance information according to an embodiment may include an illuminance value indicating brightness of light. Generally, the brightness of light may be measured in units of lux, which represents the amount of light emitted per area, but is not limited thereto. High illuminance or large illuminance indicates a bright environment, and low illuminance or small illuminance indicates a dark environment.

For example, the display device 100 may include an illuminance sensor and measure illuminance of an environment around the display device 100 by using the illuminance sensor.

Alternatively, the display device 100 may include a camera sensor and measure illuminance of the environment around the display device 100 by using the camera sensor. For example, the display device 100 may measure the illuminance by directly using the camera sensor or may obtain an illuminance value by capturing an image using the camera sensor and analyzing the captured image.

However, the present disclosure is not limited thereto, and the display device 100 according to an embodiment may obtain the information regarding illuminance of the environment around the display device 100 by using various methods.

The display device 100 according to an embodiment may adjust the corner area of the screen such that curvature of the corner of the screen has a first curvature corresponding to the illuminance information obtained in operation S210 (S220).

For example, the display device 100 may pre-set a value of the first curvature of the corner of the screen, corresponding to the illuminance value. The value of the first curvature of the corner of the screen, corresponding to the illuminance value, may decrease when the illuminance value increases, and may increase when the illuminance value decreases.

The display device 100 may control the corner of the screen to have the first curvature by displaying the black image in the partial area of the corner area of the screen or by deactivating the operation of the partial area.

The display device 100 according to an embodiment may display image content on the screen in which the first curvature has been applied to the corner (S230).

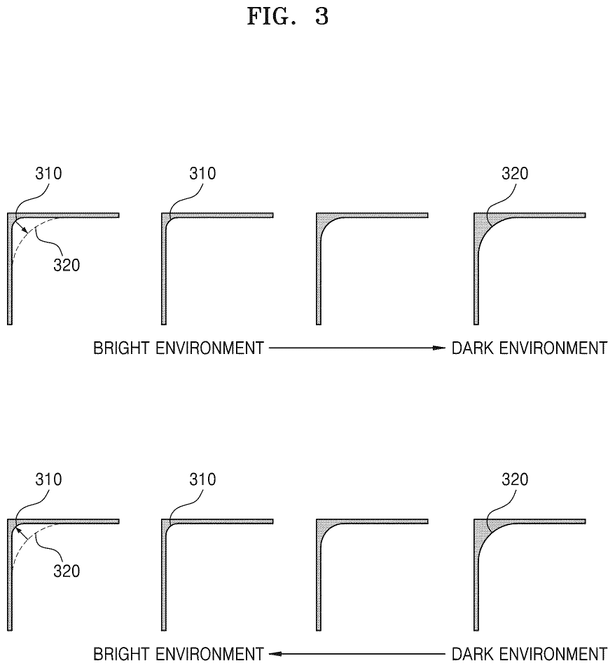

FIG. 3 is a diagram for describing an operation in which curvature of a corner of a screen of a display device changes according to illuminance, according to an embodiment.

For convenience of description, FIG. 3 will be described based on the first corner area 11 of FIG. 1.

Referring to FIG. 3, the display device 100 according to an embodiment may set a range of curvature values of the corner of the screen. For example, the display device 100 may set a minimum curvature value 310 and a maximum curvature value 320 of the corner of the screen. When the minimum curvature value 310 and the maximum curvature value 320 are set, the curvature of the corner of the screen may have a value between the minimum curvature value 310 and the maximum curvature value 320.

An illuminance value around a display device according to an embodiment and a curvature value applied to a corner of a screen, corresponding to the illuminance value, may have an inverse proportional relationship.

For example, the curvature of the corner of the screen may be set to have the minimum curvature value when the illuminance value around the display device is equal to or greater than a first threshold value. The curvature of the corner of the screen may be set to have the maximum curvature value when the illuminance value around the display device is a second threshold value or less. When the illuminance value around the display device changes from the first threshold value to the second threshold value, the curvature of the corner of the screen may be set to be changed from the minimum curvature value to the maximum curvature value.

When the illuminance value around the display device changes from the second threshold value to the first threshold value, the curvature of the corner of the screen may be set to be changed from the maximum curvature value to the minimum curvature value.

Accordingly, when the illuminance value around the display device is high (when bright), the curvature value of the corner of the screen may be low such that the corner of the screen of the display device appears close to a rectangle. In a bright environment, the appearance of the display device (e.g., an original shape of a display panel) is well recognized, and thus, the corner of the screen may be adjusted to be close to a rectangle so as to reduce a sense of difference from the appearance of the display device.

On the other hand, when the illuminance value around the display device is low (when dark), the appearance of the display device is less recognized than in the bright environment, and thus, even if the curvature value of the corner of the screen is high, a user may feel a less sense of difference from the appearance of the display device. Accordingly, when the illuminance value around the display device is low (when dark), the curvature value of the corner of the screen may be increased so as to increase immersion in content displayed on the display device.

FIG. 4 is a diagram for describing a method by which a display device applies curvature to a corner of a screen, according to an embodiment.

A corner area 410 shown in FIG. 4 may be the first corner area 11 of the display device 100 shown in FIG. 1. In FIG. 4, for convenience of description, a method of applying curvature to a corner of a screen will be described based on the first corner area 11.

The display device 100 according to an embodiment may divide the corner area 410 into a first area 420 and a second area 430, based on a value of curvature to be applied to the corner of the screen. For example, when a value of the first curvature is applied to the corner of the screen, the display device 100 may divide the corner area 410 into the first area 420 and the second area 430, based on a curve 440 having the value of the first curvature.

The display device 100 may generate a black image corresponding to the first area 420 and display the same in the first area 420. The black image may indicate an image in which pixel values included in an image are all 0. For example, the display device 100 may set all pixel values corresponding to the first area 420 to 0.

Alternatively, the display device 100 may deactivate an operation of the first area 420. For example, the display device 100 may control the display such that a signal or power corresponding to the first area 420 is not applied.

In FIG. 4, the corner area 410 is described as the first corner area 11 of FIG. 1, but the present disclosure is not limited thereto, and a method of applying curvature to the corner area 410 may be applied to the second, third, and fourth corner areas 12, 13, and 14 of FIG. 1 in a same manner.

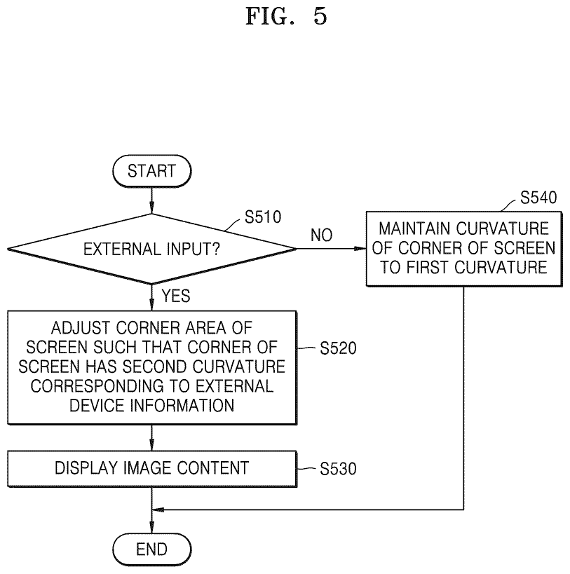

FIG. 5 is a flowchart of operations in which a display device controls curvature of a corner of a screen, according to an embodiment.

Referring to FIG. 5, the display device 100 according to an embodiment may receive content from an external device connected to the display device 100. The external device according to an embodiment may be a device configured to reproduce content and provide the content to the display device 100. For example, the content may indicate multimedia content and may include an image, a video, audio, text, a game, or an application, but is not limited thereto. The display device 100 may display, on the display, the content received from the external device.

The display device 100 may determine whether image content (e.g., image data) is being received from the external device (S510).

When the image content is being received from the external device, the display device 100 may adjust the corner area of the screen such that the corner of the screen of the display device 100 has the second curvature corresponding to external device information (S520).

The external device information may be pre-stored in the display device 100 or received from the external device. The external device information may include type information of the external device, genre information of content provided by the external device, and curvature value information of a screen corresponding to the external device.

For example, the display device 100 may determine a value of the second curvature to be applied to the corner area of the screen according to the type information of the external device or the genre information of the content provided by the external device. Alternatively, when the external device information includes the curvature value of the screen, the display device 100 may determine the curvature value as the value of the second curvature to be applied to the corner area of the screen.

The display device 100 may apply the determined value of the second curvature to the corner area of the screen. Because a method by which the display device 100 applies the curvature to the corner area of the screen has been described in detail with reference to FIG. 4, detailed descriptions will not be provided again.

The display device 100 according to an embodiment may display the image content received from the external device, on the screen in which the curvature of the corner has been adjusted (S530).

When the image content is not received from the external device, the display device 100 may maintain the curvature of the corner of the screen of the display device 100 to the first curvature corresponding to the illuminance value (S540).

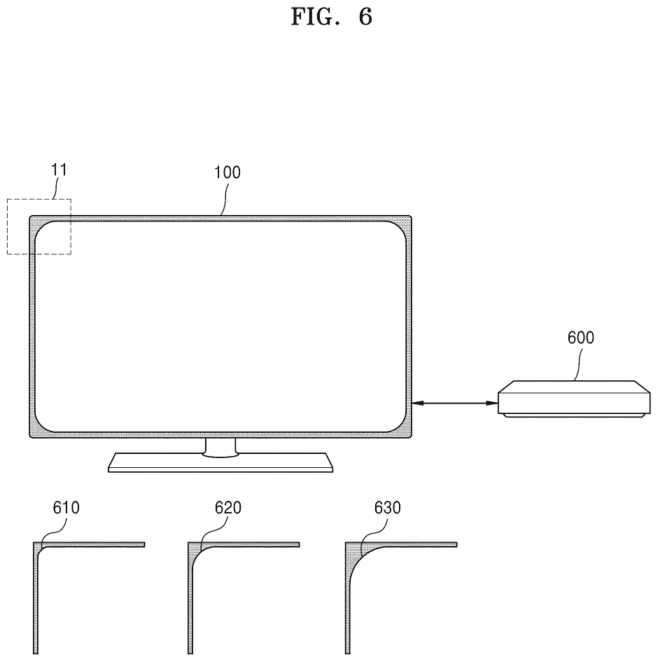

FIG. 6 is a diagram for describing an operation in which a display device controls curvature of a corner of a screen according to external device information, according to an embodiment.

Referring to FIG. 6, the display device 100 according to an embodiment may be connected to at least one external device 600. The external device 600 according to an embodiment may include a set-top box, a Blu-ray disk player, a digital versatile disk (DVD) player, a game device, a digital camera, a camcorder, a streaming device, or a home theater. Alternatively, the external device 600 may include various electronic devices, such as a smart phone, a tablet PC, a mobile terminal, a video phone, an e-book reader, a desktop PC, a laptop PC, a netbook computer, a PDA, a PMP, a navigation device, an MP3 player, and a wearable device.

The display device 100 according to an embodiment may be connected to the external device 600 through wired or wireless communication. For example, the display device 100 may be connected to the external device 600 through a high-definition multimedia interface (HDMI) port, a mobile high-definition link (MHL) port, a universal serial bus (USB) port, a display port (DP), a thunderbolt port, a video graphics array (VGA) port, an RGB port, a D-subminiature (D-SUB), a digital visual interface (DVI), a component jack, or a PC port. However, the present disclosure is not limited thereto, and the display device 100 may be connected to the external device 600 through short-range wireless communication, such as wireless local area network (LAN) (e.g., Wi-Fi) or Bluetooth. The display device 100 may transmit or receive a video, audio, and additional information by using communication connected to the external device 600.

When image content is being received from the external device 600, the display device 100 according to an embodiment may adjust the corner area of the screen such that the corner of the screen of the display device 100 has the second curvature corresponding to external device information of the external device 600.

The external device information may include type information of the external device 600, genre information of content provided by the external device 600, and curvature value information of a screen corresponding to the external device 600.

The display device 100 according to an embodiment may apply different curvature values to the corner of the screen depending on a type of the external device 600 and a genre of content provided by the external device 600. For example, the display device 100 may apply, to the first corner area 11 of the screen, a 2-1 curvature 610 when the external device 600 is a PC, a 2-2 curvature 620 when the external device 600 is a game device and provides a first type game, and a 2-3 curvature 630 when the external device 600 is a game device and provides a second type game.

Because a method by which the display device 100 applies the curvature to the corner area of the screen has been described in detail with reference to FIG. 4, detailed descriptions will not be provided again.

For convenience of description, FIG. 6 has been described based on the first corner area 11, but the present disclosure is not limited thereto, and the 2-1 curvature 610, the 2-2 curvature 620, and the 2-3 curvature 630 may also be applied to other corner areas (e.g., the second, third, and fourth corner areas 12, 13, and 14) of the display device 100.

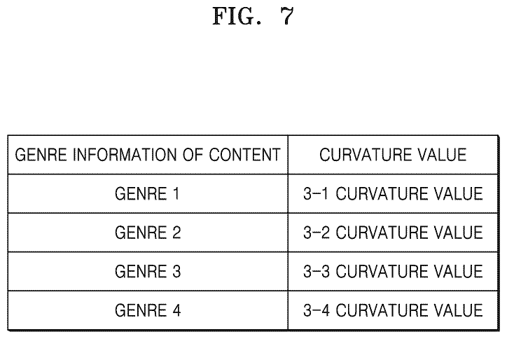

FIG. 7 is a diagram for describing an operation in which a display device controls curvature of a corner of a screen according to genre information of content, according to an embodiment.

Referring to FIG. 7, the display device 100 according to an embodiment may pre-set a curvature value corresponding to genre information of image content displayed on the display. Here, the curvature value may be set through a user input.

A genre of the image content may be one of standards for classifying the image content. The image content may be classified as a specific genre according to content, a presentation type, or target of the image content. For example, the genre of the image content may include animation, drama, sports, documentary, action, horror, comedy, romance, or science fiction (SF)/fantasy.

As shown in FIG. 7, a curvature value corresponding to Genre 1 (e.g., an animation) may be set to a 3-1 curvature value, a curvature value corresponding to Genre 2 (e.g., a movie) may be set to a 3-2 curvature value, and a curvature value corresponding to Genre 3 (e.g., a drama) may be set to a 3-3 curvature value. Also, a curvature value corresponding to Genre 4 (e.g., a game) may be set to a 3-4 curvature value. Genres and curvature values corresponding to the genres shown in FIG. 7 are only examples and are not limited thereto.

The display device 100 according to an embodiment may identify the genre of the image content, based on information about the image content, information about an external device providing the image content, and the like. For example, the information about the image content may include data on a category, content description, and content characteristics of the image content, which are set by a manufacturer or a provider of the image content. The information about the external device providing the image content may include type information of the external device, and for example, when the external device is a game device, the display device 100 may identify the genre of the image content as a game. When the genre of the image content is identified as a game, the display device 100 may apply the 3-4 curvature value to the corner of the screen.

Alternatively, when the genre of the image content is identified as an animation, the display device 100 may apply the 3-1 curvature value to the corner of the screen.

Because a method by which the display device 100 applies the curvature to the corner area of the screen has been described in detail with reference to FIG. 4, detailed descriptions will not be provided again.

The display device 100 according to an embodiment may set the minimum curvature value or the maximum curvature value of the corner of the screen, based on the genre information of the image content.

For example, the display device 100 may set different minimum curvature values according to genres of the image content such that, even when the illuminance value around the display device 100 is equal to or greater than the first threshold value, the curvature of the corner of the screen does not become smaller than the minimum curvature value set according to the genre of the image content. Alternatively, the display device 100 may set different maximum curvature values according to genres of the image content such that, even when the illuminance value around the display device 100 is equal to or less than the second threshold value, the curvature of the corner of the screen does not become larger than the maximum curvature value set according to the genre of the image content.

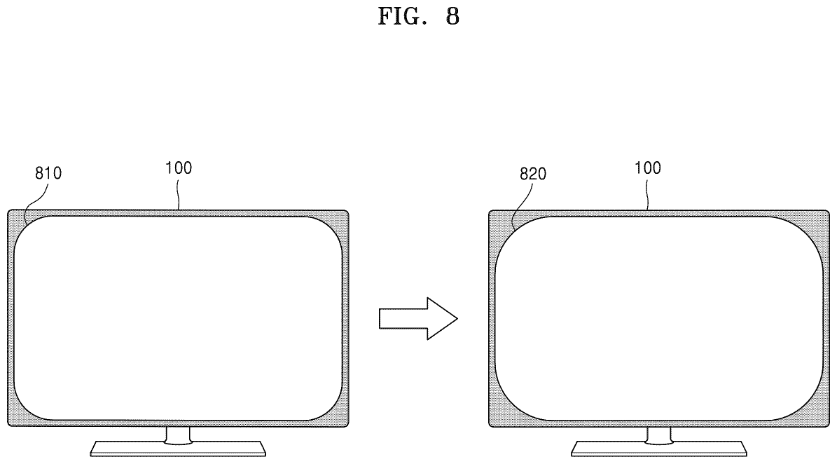

FIG. 8 is a diagram showing an example in which a display device adjusts curvature of a corner of a screen when content is switched, according to an embodiment.

Referring to FIG. 8, the display device 100 according to an embodiment may display first image content. For example, a genre of the first image content may be a movie. The display device 100 may apply, to the corner of the screen, a 3-2 curvature value 810 corresponding to genre information (movie) of the first image content.

Image content displayed on the display device 100 may be switched based on a user input. For example, the first image content displayed on the display device 100 may be switched to second image content, based on a user input of changing a channel or switching an external input. Here, a genre of the second image content may be an animation. The display device 100 may apply, to the corner of the screen, a 3-1 curvature value 820 corresponding to genre information (animation) of the second image content. For example, the display device 100 may change the curvature value of the corner area of the screen from the 3-2 curvature value 810 to the 3-1 curvature value 820. The 3-1 curvature value 820 may be greater than the 3-2 curvature value 810.

When changing the curvature value of the corner area of the screen from the 3-2 curvature value 810 to the 3-1 curvature value 820, the display device 100 may display a black image in the corner area or gradually increase a size of a first area where an operation is deactivated.

The display device 100 according to an embodiment may change a speed of changing a curvature value according to a genre of content being changed. For example, the display device 100 may set a speed of changing a curvature value when first genre content is switched to second genre content to be different from a speed of changing a curvature value when third genre content is switched to fourth genre content.

Alternatively, the display device 100 may change the speed of changing the curvature value according to whether the curvature value is increased or decreased. For example, the display device 100 may change the curvature value slowly when the curvature value is increased (becomes larger), and change the curvature value quickly when the curvature value is decreased (becomes smaller).

Alternatively, the display device 100 may change the curvature value slowly when the curvature value is decreased (becomes smaller), and change the curvature value quickly when the curvature value is increased (becomes larger). However, the present disclosure is not limited thereto.

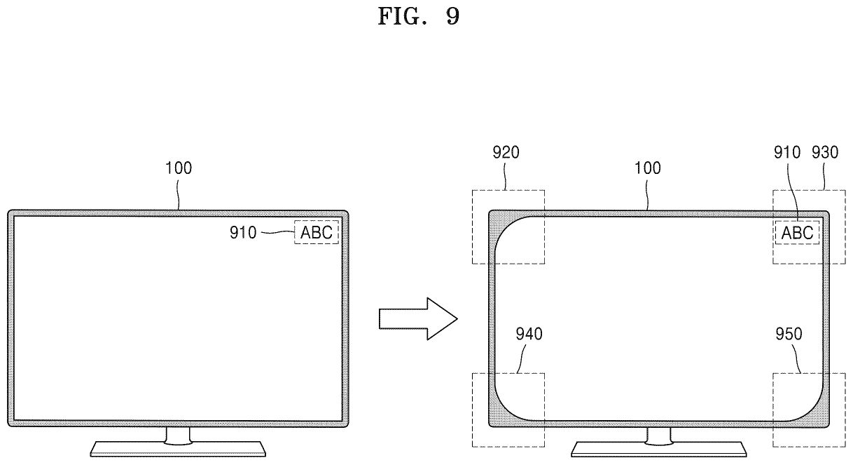

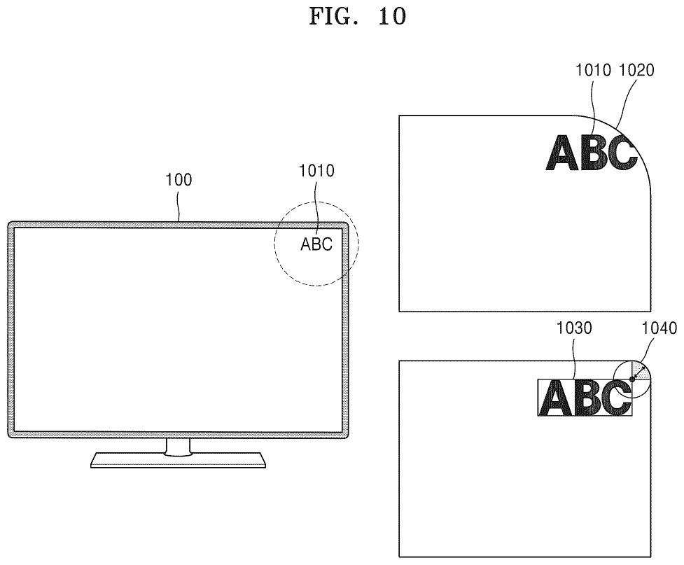

FIGS. 9 and 10 are diagrams for describing a method by which, when a logo is included in a corner area of a screen, a display device applies curvature to the corner area of the screen, according to an embodiment.

Referring to FIG. 9, the display device 100 according to an embodiment may detect a logo 910 included in content. The logo 910 is designed such that a name related to a specific company or product is uniquely identified, and for example, indicates a letter, a shape, an image, or a combination thereof representing a broadcasting station or a program. Logo information may be pre-registered or stored in the display device 100. For example, the logo information may include information about a shape of a logo corresponding to a specific channel, information about an area where the logo corresponding to the specific channel is displayed on a screen, and information about a time when the logo corresponding to the specific channel is displayed on the screen.

The display device 100 according to an embodiment may detect the logo 910 in a corner area of a screen output on a display, by using the pre-registered or stored logo information.

Alternatively, because it is highly likely that the logo 910 may be present in the corner area of the screen, the display device 100 may compare pixels between frames for the corner area of the screen and detect, as a logo area, a portion where a difference between values of the pixels is less than a pre-set value.

Alternatively, the display device 100 may include an appropriate logic, circuit, interface, and/or code that may operate to detect the logo area, and may detect the logo 910 included in image content by using the logic, circuit, interface, and/or code, and obtain information about a size and location of the detected logo 910.

As shown in FIG. 9, the display device 100 according to an embodiment may not apply curvature to the corner area of the screen, when the logo 910 is detected. For example, the display device 100 may not apply a curvature value corresponding to the image content displayed on the display, to the corner area of the screen.

Alternatively, the display device 100 may not apply the curvature to the corner area of the screen corresponding to the logo area, when the logo 910 is detected. For example, the display device 100 may apply a curvature value corresponding to the image content displayed on the display to a first corner area 920, a third corner area 940, and a fourth corner area 950 of the screen, and may not apply the curvature value to a second corner area 930 where the logo area is present.

Accordingly, the display device 100 may prevent a portion of the logo 910 included in content from not being displayed.

Referring to FIG. 10, when a logo 1010 is detected, the display device 100 according to an embodiment may change a curvature value applied to a corner area of a screen, based on a logo area.

For example, as shown in FIG. 10, a maximum curvature value of curvature corresponding to image content displayed on the display device 100 may be a first value 1020. Here, when the first value 1020 is applied to the corner area of the screen, a portion of the logo 1010 located in the corner area of the screen may not be displayed.

Accordingly, when the logo 1010 is detected in the corner area of the screen, the display device 100 may change the maximum curvature value of the curvature, based on a logo area 1030.

The display device 100 according to an embodiment may change the maximum curvature value of the curvature to a second value 1040, based on information about a shape of a logo and information about an area where a logo corresponding to a specific channel is displayed on a screen. For example, the display device 100 may change the maximum curvature value of the curvature to the second value 1040 so that the entire logo area 1030 is displayed even when the maximum curvature value of the curvature is applied, based on a location of a corner point of the logo area 1030, as shown in FIG. 10. The second value 1040 may be greater than the first value 1020. However, this is only an example, and a maximum value of curvature applied to a corner area of a screen may be changed through various methods.

Alternatively, the display device 100 may adjust the curvature value applied to the corner area of the screen to a third value so that the entire logo area 1030 is displayed on the screen, based on the logo area 1030.

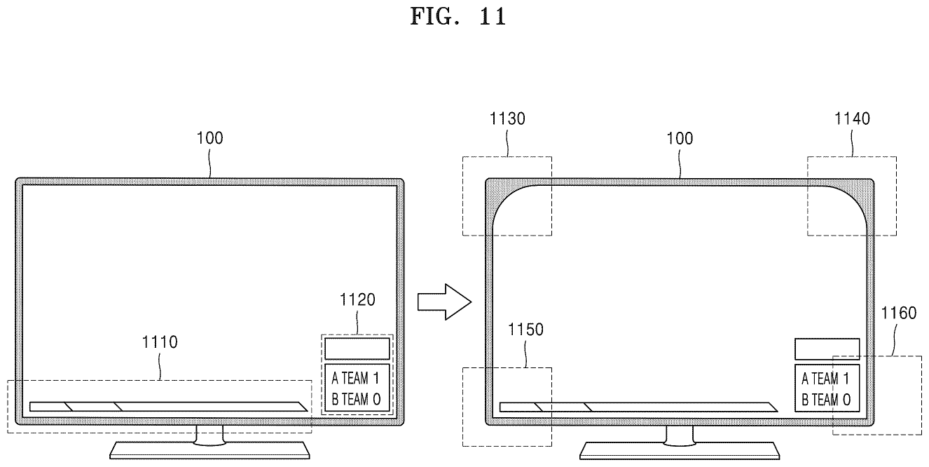

FIG. 11 is a diagram for describing a method by which, when an object is present in an edge area of a screen, a display device applies curvature to a corner area of the screen, according to an embodiment.

Referring to FIG. 11, the display device 100 according to an embodiment may identify whether an object is present in an edge area of a screen where content is displayed.

Here, the object may include a menu, a list, text, a subtitle, information about the content, and channel information, and may be distinguished from an image displayed on the screen. However, the present disclosure is not limited thereto.

Information about content, a channel, or a program, which includes the object, may be pre-registered or stored. The display device 100 according to an embodiment may detect whether the object is present in the edge area of the screen, based on the pre-registered or stored information about the content, the channel, or the program, which includes the object.

Alternatively, the display device 100 may include an appropriate logic, circuit, interface, and/or code that may operate to detect the object included in the content, and may detect the object included in the content by using the logic, circuit, interface, and/or code, and obtain information about a size and location of the detected object.

As shown in FIG. 11, when the object is detected in the edge area of the screen, the display device 100 according to an embodiment may not apply curvature to a corner area of the screen, corresponding to an object area. For example, when a menu list 1110 or important information 1120 included in the content are detected in a bottom area of the screen, the display device 100 may apply a curvature value corresponding to image content displayed on the display only to top corner areas 1130 and 1140, and not apply the curvature value to bottom corner areas 1150 and 1160.

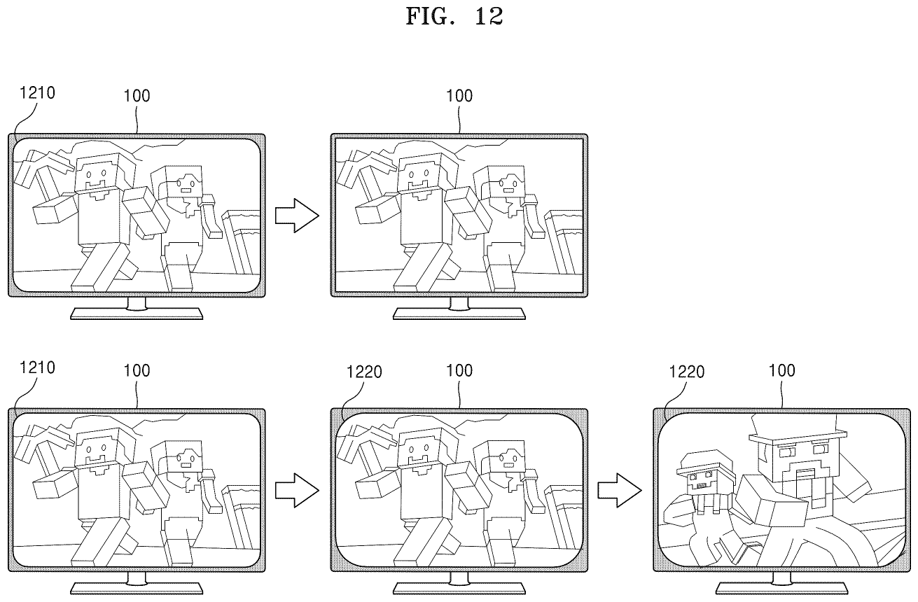

FIG. 12 is a diagram for describing an operation in which a display device controls curvature of a corner of a screen, based on a user input, according to an embodiment.

Referring to FIG. 12, the display device 100 according to an embodiment may determine whether to apply curvature to the corner of the screen or may change an applied curvature value, based on a user input.

For example, the display device 100 may output, through the display, first content of a first genre. At this time, the display device 100 may apply, to the corner area of the screen, a first curvature value 1210 corresponding to the first genre.

The display device 100 may receive a first user input of requesting not to apply the curvature to the first content. For example, the display device 100 may receive, from a control device, a control signal or a control command corresponding to the first user input. The control device may include a remote controller, a keyboard, or a mouse, and may transmit or receive data, information, and a signal to or from the display device 100 through wired or wireless communication. However, the present disclosure is not limited thereto.

Based on receiving the first user input, the display device 100 may not apply the curvature to the corner area of the screen and may maintain a rectangular frame shape when outputting the first content through the display.

Alternatively, the display device 100 may receive a second user input requesting to apply a second curvature value 1220 to the first content. For example, the display device 100 may receive, from the control device, a control signal or a control command corresponding to the second user input.

Based on receiving the second user input, the display device 100 may apply, to the corner area of the screen, the second curvature value 1220 rather than the first curvature value 1210.

Also, the display device 100 according to an embodiment may control the second curvature value 1220 to be applied to the corner area of the screen when outputting content of a same or similar genre as the first genre of the first content, based on receiving the second user input.

For example, the display device 100 may apply, to the corner area of the screen, the second curvature value 1220 rather than the first curvature value 1210 when outputting second content (e.g., a second animation) of the first genre through the display. However, the present disclosure is not limited thereto.

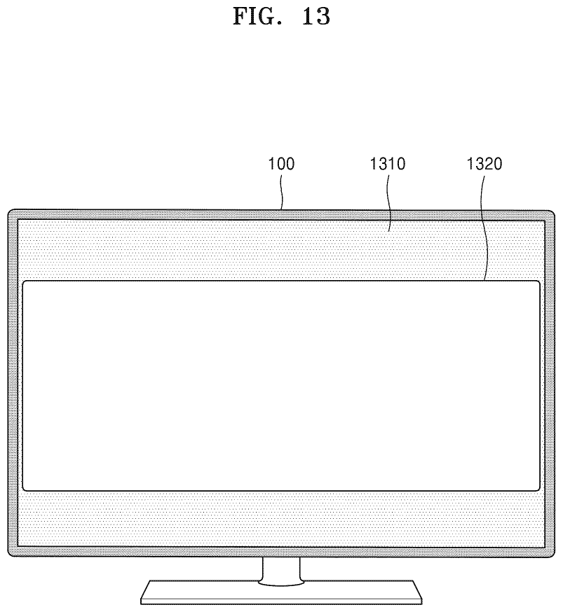

FIG. 13 is a diagram illustrating a method by which, when a letterbox is displayed on a display screen, a display device applies curvature, according to an embodiment.

Referring to FIG. 13, when a screen ratio of the display and a screen ratio of the image content are different from each other, the display device 100 according to an embodiment may maintain the screen ratio of the image content by displaying black bars in top and bottom areas or left and right areas of the image content. The displayed black bar is referred to as a letterbox 1310.

For example, when the screen ratio of the display is 4:3 and the screen ratio of the image content is 16:9, the black bars (letterbox 1310) may be displayed in the top and bottom areas of the image content while displaying the image content without changing a ratio. Accordingly, the image content may be displayed without distortion by maintaining the screen ratio of the image content to 16:9.

When the letterbox 1310 is displayed on the display screen, the display device 100 according to an embodiment may apply curvature to a first area 1320 where the image content is displayed, rather than to the letterbox 1310. For example, as shown in FIG. 13, the display device 100 may apply a curvature value corresponding to the image content to corner areas of the first area 1320.

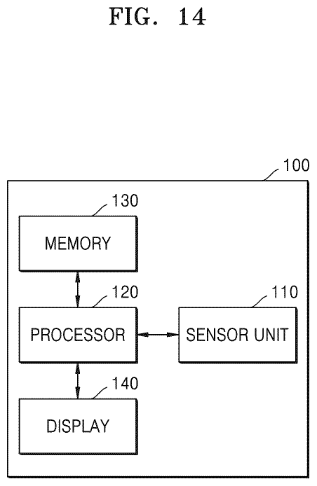

FIG. 14 is a block diagram of a configuration of a display device, according to an embodiment.

Referring to FIG. 14, the display device 100 according to an embodiment may include a sensor unit 110, a processor 120, a memory 130, and a display 140.

The sensor unit 110 according to an embodiment may obtain information regarding illuminance around the display device 100. The illuminance information according to an embodiment may include an illuminance value indicating brightness of light. Generally, the brightness of light may be measured in units of lux, which represents the amount of light emitted per area, but is not limited thereto. High illuminance or large illuminance indicates a bright environment, and low illuminance or small illuminance indicates a dark environment.

The sensor unit 110 may include an illuminance sensor and measure illuminance around the display device 100 by using the illuminance sensor. Alternatively, the sensor unit 110 may include a camera sensor and measure illuminance around the display device 100 by using the camera sensor. However, the present disclosure is not limited thereto, and the sensor unit 110 may obtain information regarding illuminance around the display device 100 by using various sensors.

The processor 120 according to an embodiment controls general operations of the display device 100 and a signal flow between internal components of the display device 100, and performs a function of processing data.

The processor 120 may include a single core, a dual core, a triple core, a quad core, or a multiple core. Also, the processor 120 may include a plurality of processors. For example, the processor 120 may include a main processor (not shown) and a sub-processor (not shown) operating in a sleep mode.

Also, the processor 120 may include at least one of a central processing unit (CPU), a graphics processing unit (GPU), or a video processing unit (VPU). Alternatively, according to an embodiment, the processor 120 may be implemented in the form of a system-on-chip (SoC) in which at least one of CPU, GPU, and VPU is integrated. Alternatively, the processor 120 may further include a neural processing unit (NPU).

The memory 130 according to an embodiment may store various types of data, programs, or applications for driving and controlling the display device 100.

Also, the program stored in the memory 130 may include one or more instructions. The program (one or more instructions) or application stored in the memory 130 may be executed by the processor 120.

The processor 120 according to an embodiment may control the display 140 such that a display screen corner appears to be round. The processor 120 may control curvature of the display screen corner. For example, the processor 120 may adjust a corner area of a screen such that curvature of a corner of the screen has a first curvature corresponding to the illuminance information obtained through the sensor unit 110.

For example, a value of the first curvature of the corner of the screen, corresponding to an illuminance value, may be pre-set. The value of the first curvature of the corner of the screen, corresponding to the illuminance value, may decrease when the illuminance value increases, and may increase when the illuminance value decreases.

The processor 120 according to an embodiment may control the corner of the screen to have the first curvature by displaying a black image in a partial area of the corner area of the screen or by deactivating an operation of the partial area. Because this has been described in detail with reference to FIG. 4, detailed descriptions will not be provided again.

The processor 120 according to an embodiment may determine whether content is being received from an external device connected to the display device 100. When image content is being received from the external device, the processor 120 may adjust the corner area of the screen such that the curvature of the corner of the screen has the second curvature corresponding to external device information. The external device information may include type information of the external device, genre information of content provided by the external device, and curvature value information of a screen corresponding to the external device.

For example, the processor 120 may determine a value of the second curvature to be applied to the corner area of the screen according to the type information of the external device or the genre information of the content provided by the external device. Alternatively, when the external device information includes the curvature value of the screen, the processor 120 may determine the curvature value as the value of the second curvature to be applied to the corner area of the screen.

The processor 120 may apply the determined value of the second curvature to the corner area of the screen. Because a method by which the display device 100 applies the curvature to the corner area of the screen has been described in detail with reference to FIG. 4, detailed descriptions will not be provided again.

On the other hand, when the image content is not being received from the external device, the processor 120 may maintain the curvature of the corner of the screen to the first curvature corresponding to the illuminance value.

The processor 120 according to an embodiment may control the curvature of the corner of the screen to have the third curvature corresponding to the genre information of the image content displayed on the display 140. A genre of the image content may be one of standards for classifying the image content. The image content may be classified as a specific genre according to content, a presentation type, or target of the image content. For example, the genre of the image content may include animation, drama, sports, documentary, action, horror, comedy, romance, or science fiction (SF)/fantasy. The processor 120 may identify the genre of the image content and apply different curvature values to the corner of the screen depending on the genre of the image content.

Also, the processor 120 may set the minimum curvature value or the maximum curvature value of the corner of the screen, based on the genre information of the image content.

Also, when the image content displayed on the display 140 is switched, the processor 120 may change the curvature of the corner of the screen to a curvature value corresponding to the switched image content.

The processor 120 according to an embodiment may detect a logo included in the content. The logo is designed such that a name related to a specific company or product is uniquely identified, and for example, indicates a letter, a shape, an image, or a combination thereof representing a broadcasting station or a program. Logo information may be pre-registered or stored.

When the logo is detected, the processor 120 may not apply the curvature to the corner of the screen. Alternatively, the processor 120 may not apply the curvature only to a corner area of the screen, corresponding to a logo area. Also, the processor 120 may change the maximum curvature value of the curvature applied to the corner area of the screen, based on the logo area.

The processor 120 according to an embodiment may identify whether an object is present in an edge area of the screen where the content is displayed. Here, the object may include a menu, a list, text, a subtitle, information about the content, and channel information, and may be distinguished from an image displayed on the screen. However, the present disclosure is not limited thereto.

Information about content, a channel, or a program, which includes the object, may be pre-registered or stored.

When the object is detected in the edge area of the screen, the processor 120 may not apply the curvature to the corner area of the screen, corresponding to an object area.

The processor 120 according to an embodiment may determine whether to apply curvature to the corner of the screen or may change an applied curvature value, based on a user input.

The display 140 according to an embodiment may generate a driving signal by converting an image signal, data signal, on-screen display (OSD) signal, or control signal processed by the processor 120. The display 140 may be implemented as a plasma display panel (PDP), a liquid crystal display (LCD), an organic LED (OLED), or a flexible display, or may be implemented as a 3-dimensional (3D) display. The display 140 may be configured as a touch screen to be used as an input device as well as an output device.

The display 140 according to an embodiment may operate according to control by the processor 120 such that the corner of the screen has the curvature. For example, the black image may be displayed on the partial area of the corner area of the screen or an operation of the partial area may be deactivated. Here, the partial area may be determined based on a curve having a curvature value determined by the processor 120.

The display 140 according to an embodiment may display the image content on the screen to which the curvature has been applied.

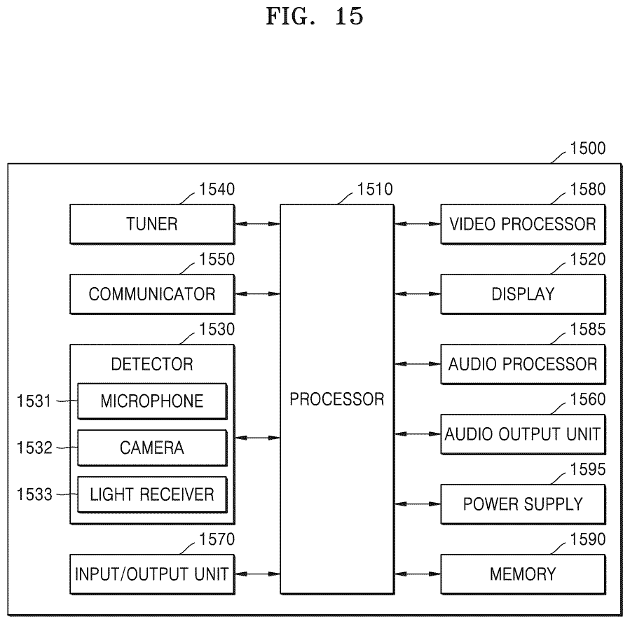

FIG. 15 is a block diagram of a configuration of a display device, according to an embodiment.

Referring to FIG. 15, a display device 1500 may be an example of the display device 100 described with reference to FIGS. 1 through 14.

Referring to FIG. 15, the display device 1500 according to an embodiment may include a tuner 1540, a processor 1510, a display 1520, a communicator 1550, a detector 1530, an input/output unit 1570, a video processor 1580, an audio processor 1585, an audio output unit 1560, a memory 1590, and a power supply 1595.

The detector 1530 may correspond to the sensor unit 110 of FIG. 14, the processor 1510 of FIG. 15 may correspond to the processor 120 of FIG. 14, the memory 1590 of FIG. 15 may correspond to the memory 130 of FIG. 14, and the display 1520 of FIG. 15 may correspond to the display 140 of FIG. 14. Accordingly, redundant details that have been described above are omitted.

The tuner 1540 according to an embodiment may tune and select only a frequency of a channel to be received by the display device 1500 among many radio wave components by performing amplification, mixing, and resonance on a broadcast signal received via wires or wirelessly. The broadcast signal includes audio, video, and additional information (for example, an electronic program guide (EPG)).

The tuner 1540 may receive a broadcast signal from various sources, such as terrestrial broadcasting, cable broadcasting, satellite broadcasting, and Internet broadcasting. The tuner 1540 may receive a broadcast signal from a source such as analog broadcasting or digital broadcasting.

The communicator 1550 according to an embodiment may transmit and receive data or a signal to and from an external device (e.g., the external device 600 or a control device) or a server. For example, the communicator 1550 may include a Wi-Fi module, a Bluetooth module, an infrared communication module, a wireless communication module, a local area network (LAN) module, an Ethernet module, or a wired communication module. Here, each communication module may be implemented in the form of at least one hardware chip.

The Wi-Fi module and the Bluetooth module may communicate through a W-Fi method and a Bluetooth method, respectively. When the Wi-Fi module or the Bluetooth module is used, various types of connection information, such as a service set identifier (SSID) or a session key, may be transmitted or received first, communication may be connected by using the same, and then various types of information may be transmitted or received. The wireless communication module may include at least one communication chip performing communication according to various wireless communication standards, such as ZigBee, 3rd generation (3G), 3G partnership project (3GPP), long-term evolution (LTE), LTE advanced (LTE-A), 4th generation (4G), and 5th generation (5G).

The communicator 1550 according to an embodiment may receive an external input image from the external device 600 according to an embodiment.

The communicator 1550 according to an embodiment may receive, from the control device, a control signal or a control command. For example, the communicator 1550 may include an infrared (IR) module configured to transmit and receive a signal to and from the control device according to IR communication standards. In detail, the communicator 1550 may receive, from the control device, a control signal or a control command corresponding to a user input (e.g., a key or button input of the control device).

The detector 1530 according to an embodiment may detect a speech of a user, an image of the user, or an interaction of the user, and may include a microphone 1531, a camera 1532, and a light receiver 1533.

The microphone 1531 receives a speech uttered by the user. The microphone 1531 may convert the received speech into an electric signal and output the electric signal to the processor 1510. The user's speech may include, for example, a speech corresponding to a menu or function of the display device 1500.

The camera 1532 may receive an image (for example, consecutive frames) corresponding to motion of the user including a gesture within a camera recognition range. The processor 1510 may select a menu displayed on the display device 1500 by using a result of recognizing the received motion or perform control corresponding to the result.

The light receiver 1533 receives an optical signal (including a control signal) received from the external control device through a light window (not shown) of a bezel of the display 1520. The light receiver 1533 may receive an optical signal corresponding to a user input (for example, touch, press, touch gesture, speech, or motion) from the control device. A control signal may be extracted from the received light signal under control by the processor 1510.

The input/output unit 1570 according to an embodiment may receive video (e.g., a moving image), audio (e.g., speech or music), and additional information (e.g., electronic program guide (EPG)) from the outside of the display device 1500. The input/output unit 1570 may include any one of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, and a PC port.

The processor 1510 controls general operations of the display device 1500 and a signal flow between the display device 1500 and internal components, and performs a function of processing data. When there is a user input or a pre-set and stored condition is satisfied, the processor 1510 may execute an operation system (OS) and various applications stored in the memory 1590.

The processor 1510 may include random access memory (RAM) storing a signal or data input from the outside of the display device 1500 or used as a storage area corresponding to various tasks performed by the display device 1500, read-only memory (ROM) storing a control program for control by the display device 1500, and a processor.

The video processor 1580 performs processes on video data received by the display device 1500. The video processor 1580 may perform various image processing, such as decoding, scaling, noise filtering, frame rate conversion, and resolution conversion, on the video data.

The audio processor 1585 performs processing on audio data. The audio processor 1585 may perform various processing, such as decoding, amplification, or noise filtering, on the audio data. The audio processor 1585 may include a plurality of audio processing modules to process audio corresponding to a plurality of pieces of content.

The audio output unit 1560 outputs audio included in a broadcast signal received through the tuner 1540 under control by the processor 1510. The audio output unit 1560 may output the audio (for example, speech or sound) input through the communicator 1550 or the input/output unit 1570. Also, the audio output unit 1560 may output audio stored in the memory 1590 under control by the processor 1510. The audio output unit 1560 may include at least one of a speaker, a headphone output terminal, or a Sony/Philips digital interface (S/PDIF) terminal.

The power supply 1595 supplies power input from an external power source to components inside the display device 1500 under control by the processor 1510. Also, the power supply 1595 may supply power output from one or more batteries (not shown) located inside the display device 1500 to the components inside the display device 1500 under control by the processor 1510.

The memory 1590 may store various types of data, programs, or applications for driving and controlling the display device 1500 under control by the processor 1510. The memory 1590 may include a broadcast receiving module, a channel control module, a volume control module, a communication control module, a voice recognition module, a motion recognition module, a light receiving module, a display control module, an audio control module, an external input control module, a power control module, a power control module of an external apparatus connected wirelessly (for example, Bluetooth), a voice database (DB), or a motion DB, which is not shown. Modules and DBs of the memory 1590 may be implemented in the form of software to perform a broadcast receiving control function, a channel control function, a volume control function, a communication control function, a voice recognition function, a motion recognition function, a light receiving control function, a display control function, an audio control function, an external input control function, a power control function, or power control function of an external device connected wirelessly (for example, Bluetooth), in the display device 1500. The processor 1510 may perform each function by using the software stored in the memory 1590.

Meanwhile, the block diagrams of the display devices 100 and 1500 of FIGS. 14 and 15 are block diagrams according to an embodiment. The components may be integrated, a component may be added, or the component may be omitted based on the specification of the display device 100 or 1500. In other words, two or more components may be integrated into one component or one component may be divided into two or more components when necessary. Also, a function performed by each block is only for describing embodiments and specific operations or devices do not limit the scope of right of the present disclosure.

A display device according to an embodiment may include a display, a sensor unit, a memory storing one or more instructions, and at least one processor configured to execute the one or more instructions.

The at least one processor may be configured to execute the one or more instructions to obtain information regarding illuminance around the display device through the sensor unit.

The at least one processor may be configured to execute the one or more instructions to control the display such that a corner of a screen displayed on the display has a first curvature corresponding to the illuminance information.

The at least one processor may be configured to execute the one or more instructions to control the display to display image content on the screen.

The at least one processor may be further configured to execute the one or more instructions to control the display to display a black image in a partial area of a corner area of the screen, such that the remaining area of the corner area has the first curvature.

The at least one processor may be further configured to execute the one or more instructions to control the display to deactivate operation of a partial area of the corner area of the screen, such that the remaining area of the corner area has the first curvature.

A value of the first curvature may decrease when an illuminance value indicated by the illuminance information increases, and increase when the illuminance value indicated by the illuminance information decreases.

The at least one processor may be further configured to execute the one or more instructions to receive the image content from an external device connected to the display device.

The at least one processor may be further configured to execute the one or more instructions to control the display such that curvature of the corner of the screen has a second curvature corresponding to type information of the external device.

The at least one processor may be further configured to execute the one or more instructions to control the display such that the curvature of the corner of the screen has a third curvature corresponding to genre information of the image content.

The at least one processor may be further configured to execute the one or more instructions to set a maximum curvature value of the corner of the screen, based on the genre information of the image content.

The at least one processor may be further configured to execute the one or more instructions to identify whether an object is present in the corner area of the screen.

The at least one processor may be further configured to execute the one or more instructions to control the display device to not apply the curvature to the corner of the screen, based on identification of the object, or to change a value of the curvature of the corner of the screen, based on an area where the object is present.

The at least one processor may be further configured to execute the one or more instructions to set the maximum curvature value of the corner of the screen, based on the area where the object is present.

The at least one processor may be further configured to execute the one or more instructions to control the display to display the image content in a first area of the screen, display a letterbox in a second area of the screen, and cause a corner of the first area to have the first curvature.

An operating method of a display device, according to an embodiment, may include obtaining information regarding illuminance around the display device.

The operating method of the display device, according to an embodiment, may include controlling a display of the display device such that a corner of a screen displayed on the display has a first curvature corresponding to the illuminance information.

The operating method of the display device, according to an embodiment, may include displaying image content on the screen.

The controlling of the display such that the corner of the screen has the first curvature may include controlling the display to display a black image in a partial area of a corner area of the screen, such that the remaining area of the corner area has the first curvature.

The controlling of the display such that the corner of the screen has the first curvature may include controlling the display to deactivate operation of the partial area of the corner area of the screen, such that the remaining area of the corner area has the first curvature.

A value of the first curvature may decrease when an illuminance value indicated by the illuminance information increases, and increase when the illuminance value indicated by the illuminance information decreases.

The operating method of the display device, according to an embodiment, may further include receiving the image content from an external device connected to the display device.

The operating method of the display device, according to an embodiment, may further include controlling the display such that curvature of the corner of the screen has a second curvature corresponding to type information of the external device.

The operating method of the display device, according to an embodiment, may further include controlling the display such that the curvature of the corner of the screen has a third curvature corresponding to genre information of the image content.

The operating method of the display device, according to an embodiment, may further include setting a maximum curvature value of the corner of the screen, based on the genre information of the image content.

The operating method of the display device, according to an embodiment, may further include identifying whether an object is present in the corner area of the screen.

The operating method of the display device, according to an embodiment, may further include controlling the display device to not apply the curvature to the corner of the screen, based on identification of the object, or to change a value of the curvature of the corner of the screen, based on an area where the object is present.

The operating method of the display device, according to an embodiment, may further include setting the maximum curvature value of the corner of the screen, based on the area where the object is present.

A display device according to an embodiment may apply curvature to a display screen corner, and thus, immersion and aesthetics may be improved.

Also, the display device according to an embodiment may apply, to a corner of a screen, a curvature value optimized according to a usage environment (e.g., illuminance around the display device, information about a connected external device, and information about a genre of content being watched), and thus, satisfaction of a user on a product may be improved.

In addition, the display device according to an embodiment may adjust the curvature value of the corner of the screen, and thus, compatibility with a third party program or external input content being reproduced on the display device may be increased.

Furthermore, the display device according to an embodiment may provide unity by maintaining visual and aesthetic experience when interoperating with other display devices (e.g., mobile display devices such as a smartphone, a tablet computer, and a smart watch) to which curvature has been applied to a corner.

An operating method of a display device, according to an embodiment, may be recorded on a computer-readable recording medium by being implemented in the form of program commands executed by using various computers. The computer-readable recording medium may include at least one of a program command, a data file, or a data structure. The program commands recorded in the computer-readable recording medium may be specially designed or well known to one of ordinary skill in the computer software field. Examples of the computer-readable recording medium include magnetic media such as hard disks, floppy disks, and magnetic tapes, optical media such as CD-ROMs and DVDs, magneto-optical media such as floptical disks, and hardware devices specially configured to store and perform program commands, such as read-only memory (ROM), random-access memory (RAM), and flash memory. Examples of the computer command include machine codes generated by a compiler, and high-level language codes executable by a computer by using an interpreter.

Furthermore, at least one of an operating method of a display device and an operating method of an electronic device, according to embodiments, may be provided by being included in a computer program product. The computer program products are products that can be traded between sellers and buyers.

The computer program product may include a software program or a computer-readable storage medium storing a software program. For example, the computer program product may include a product (for example, a downloadable application) in the form of a software program that is electronically distributable through a manufacturer of the electronic device or an electronic market (for example, Google PlayStore™ or AppStore™). For electronic distribution, at least a part of the software program may be stored in the storage medium or temporarily generated. In this case, the storage medium may be a storage medium of a server of a manufacturer, a server of an electronic market, or a relay server that temporarily stores the software program.

The computer program product may include a storage medium of a server or a storage medium of a client device in a system including the server and the client device. Alternatively, when there is a third device, e.g., a smartphone, that communicates with the server or the client device, the computer program product may include a storage medium of the third device. Alternatively, the computer program product may include the software program transmitted from the server to the client device or the third device, or transmitted from the third device to the client device.

In this case, one of the server, the client device, and the third device may perform a method according to embodiments by executing the computer program product. Alternatively, two or more of the server, the client device, and the third device may execute the computer program product to perform the method according to the embodiments in a distributed fashion.

For example, the server, for example, a cloud server or an artificial intelligence server, may execute the computer program product stored in the server to control the client device communicatively connected to the server to perform the method according to the embodiments.

While example embodiments have been particularly shown and described in detail, it will be understood by one of ordinary skill in the art that various changes in form and details may be made therein without departing from the scope of the present disclosure as defined by the following claims.

What is claimed is:

1. A display device comprising:
a display configured to display an image content on a screen,
wherein the screen comprises at least one corner area, and
wherein the at least one corner area comprises a corner;
a sensor;
memory configured to store one or more instructions; and
at least one processor configured to execute the one or more instructions,
wherein the one or more instructions, when executed the at least one processor individually or collectively, cause the display device to:
obtain information regarding illuminance around the display device through the sensor;
control the display to display the image content on the screen with the corner having a curvature based on at least one of:
illuminance information regarding the illuminance around the display, or external device information; and
control the display to display the image content on the screen.

2. The display device of claim 1, wherein the one or more instructions, when executed the at least one processor individually or collectively, cause the display device to:
control the display to display a black image in a partial area of the corner area of the screen, such that a remaining area of the corner area has the curvature.

3. The display device of claim 1, wherein the one or more instructions, when executed the at least one processor individually or collectively, cause the display device to:
control the display to deactivate an operation of a partial area of the corner area of the screen, such that a remaining area of the corner area has the curvature.

4. The display device of claim 1, wherein a value of the curvature decreases based on an illuminance value indicated by the illuminance information increasing, and increases based on the illuminance value decreasing.

5. The display device of claim 1, wherein the one or more instructions, when executed the at least one processor individually or collectively, cause the display device to:
receive the image content from the external device connected to the display device; and
control the display to display the image content on the screen with the corner having the curvature based on the external device information, and
wherein the external device information comprises type information of the external device.

6. The display device of claim 1, wherein the one or more instructions, when executed the at least one processor individually or collectively, cause the display device to:
receive the image content from the external device connected to the display device; and
control the display to display the image content on the screen with the corner having the curvature based on the external device information, and
wherein the external device information comprises genre information of the image content.

7. The display device of claim 6, wherein the one or more instructions, when executed the at least one processor individually or collectively, cause the display device to:
set a maximum curvature value of the corner of the screen based on the genre information of the image content.

8. The display device of claim 1, wherein the one or more instructions, when executed the at least one processor individually or collectively, cause the display device to:
based on identifying that an object is present at an edge of the screen or in the corner of the screen, control the display device to change a value of the curvature of the corner of the screen based on an area where the object is present on the screen.

9. The display device of claim 8, wherein the one or more instructions, when executed the at least one processor individually or collectively, cause the display device to:
set a maximum curvature value of the corner of the screen based on the area where the object is present.

10. The display device of claim 1, wherein the one or more instructions, when executed the at least one processor individually or collectively, cause the display device to:
control the display to display the image content in a first area of the screen, display a letterbox in a second area of the screen, and cause a corner of the first area to have the curvature.

11. An operating method of a display device, the operating method comprising:
obtaining illuminance information indicative of illuminance around the display device; and
controlling a display of the display device to display image content on a screen with a corner having a curvature corresponding to the illuminance information; and
displaying image content on the screen.

12. The operating method of claim 11, wherein the controlling the display of the display device to display the image content on the screen with the corner having the curvature comprises controlling the display to display a black image in a partial area of a corner area of the screen, such that a remaining area of the corner area has the curvature.

13. The operating method of claim 11, wherein the controlling the display of the display device to display the image content on the screen with the corner having the curvature comprises controlling the display to deactivate operation of a partial area of a corner area of the screen, such that a remaining area of the corner area has the curvature.

14. The operating method of claim 11, wherein a value of the curvature decreases when an illuminance value indicated by the illuminance information increases, and increases when the illuminance value decreases.

15. A non-transitory computer-readable storage medium storing instructions that, when executed by a processor performs the method of claim 11.

16. A display device comprising:
a display configured to display on a screen,
wherein the screen comprises at least one corner area, and
wherein the at least one corner area comprises a corner;
a sensor;
a memory configured to store one or more instructions; and
at least one processor configured to execute the one or more instructions,
wherein the one or more instructions, when executed the at least one processor individually or collectively, cause the display device to:
control the display to display the image content on the screen with the corner having a curvature based on an absence of a displayed object in the corner area; and
control the display to display the image content on the corner having no curvature based on a presence of the displayed object in the corner area.

17. The operating method of claim 11, further comprising:
adjusting the curvature based on external device information; and
controlling the display of the display to display the image content on the screen with the corner having the adjusted curvature.

18. The operating method of claim 12, wherein the external device information is genre information of the image content provided by an external device or type information of the external device.
